(19) United States
(12) Patent Application Publication
(10) Pub. No.: US 2002/0104472 A1
(43) Pub. Date: Aug. 8, 2002

(54) Temporary airport safety ground transportation markers

(76) Inventor: Timothy W. Neubert, Palm Harbor, FL (US)

Correspondence Address: Dennis L. Cook, Esq., Fowler White Boggs Banker, Suite 1700, 501 E. Kennedy Blvd., Tampa, FL, 33602, US

(21) Appl. No.: 10/113,383

(22) Filed: Mar. 29, 2002

Related U.S. Application Data
(60) Provisional application No. 60/281,067, filed on Apr. 2, 2001.

(51) Int. Cl. G01D 21/00

(52) U.S. Cl. 116/209

(57) ABSTRACT

The present invention relates a temporary, moveable marker system for directing air or ground traffic. It relates to a marker having a shape that conveys information to air or ground traffic, such as an “X”, and being sized at least large enough so as to be seen by air or ground traffic. The marker is displayed on a generally horizontal surface in a generally horizontal fashion and may include elements for receiving fasteners to permit the marker to be fastened to the ground or other generally horizontal surface.

### CROSS-REFERENCE TO RELATED APPLICATION

The present application claims the benefit of previously filed co-pending U.S. Provisional Patent Application, Serial No. 60/281,067, filed Apr. 2, 2001.

### BACKGROUND OF THE INVENTION

The present invention relates to ground traffic markers, and more particularly to an economical, portable or temporary marker to inform pilots of a closed taxiway, runway, or other ground surface. Although various types of runway markers and lights exist in the prior art, these inventions are designed to be permanently affixed, and therefore are unsuitable as a temporary, portable marker. Therefore, airports are presently utilizing snow fencing or construction mesh as a low cost, day light means for closing off and indicating to pilots that a particular runway, taxiway, or other ground surface is closed to aircraft travel. These materials are cumbersome to work with, and have the attendant problems of the material falling down, blowing away, curling up, etc., while being placed or after being placed across the entrance of the area to be closed. Removing and storing such mesh or fencing materials is also cumbersome and time consuming. A high cost option currently available to airports is a mobile warning light apparatus, such as the one disclosed in U.S. Pat. No. 5,122,797, issued to Wanasz on Jun. 16, 1992. This warning light can be mounted on a vehicle or a wheeled frame that can be towed by a vehicle. These warning light assemblies are expensive, and must be mounted on a vehicle or wheeled frame in order to be moved and used. Further, the usefulness of a lighted apparatus is questionable since airports can simply turn off the runway or taxiway lights to inform pilots that these areas are closed.

Accordingly, there is a need in airport management for a low cost, effective, and expedient means for informing pilots of ground surfaces that are closed to aircraft traffic during daylight hours.

### SUMMARY OF THE INVENTION

Therefore, it is an object of the present invention to provide an economic and expeditious means of informing pilots of closed ground surfaces, in the form of a portable ground surface marker, that meets all requirements and needs for high visibility and obtrusiveness. A further object of this invention is to provide a portable marker that can be utilized in other ground traffic situations, such as highways, parking lots, and the like.

In accordance with these objectives, the present invention comprises an economic, durable, lightweight, highly conspicuous and visible marker that is resistant to environmental wear and tear such as mildew, sunlight, cold, and fire. The invention includes any marker shape that conveys information to air or ground traffic. The minimum size of the present invention is limited only by the need to see it from the air. Although not lighted, it effectively serves the purpose of informing pilots of closed ground surfaces in virtually all circumstances. This is because in the absence of daylight, aircraft do not proceed onto ground surfaces that are not lighted, i.e., the absence of lights provides the notification in the dark, and the present invention provides the notification during daylight.

Although durable, it is lightweight such that it can be expeditiously moved and placed anywhere on a generally horizontal surface, such as the ground. In the preferred use, it may be placed in the center of the entrances of a taxiway or runway, to alert pilots of aircraft or other ground vehicles that the area is closed to traffic. It is a cost-effective solution for airports of all sizes, that can be safely utilized by a single person, and can easily be stored in airport emergency or maintenance vehicle compartments. When folded up for storage, this marker fits easily into any type of suitably sized storage bag.

Other features and objects of the present invention are disclosed in the Detailed Description Of The Preferred Embodiment, taken in conjunction with the attached drawings.

### BRIEF DESCRIPTION OF THE DRAWINGS

The following figures set forth the preferred embodiment of the present invention:

FIG. 1 is a diagram depicting the overall appearance of the preferred embodiment.

FIG. 2 depicts a rectangular section that comprises one-half of the marker for a runway application embodiment.

FIG. 3 depicts an embodiment of the marker placed in the center of a runway.

FIG. 4 depicts the two rectangular components of the preferred embodiment as they would appear when rolled up for storage.

### DETAILED DESCRIPTION OF THE PREFERRED EMBODIMENT

The preferred embodiment is an “X” shaped marker constructed from a vinyl coated nylon material that is normally used for windscreen and stadium cover applications, such as the Covermaster® Vinyl Windscreen System manufactured by Covermaster Inc. This material provides a lightweight marker with a solid appearance to clearly indicate that a runway is closed for aircraft traffic. This vinyl coated windscreen material is highly resistant to mildew and ultraviolet light. It has a polyester fabric base with a burst strength of 300 lbs/2 inches, and a cold crack resistance of at least minus 40 degrees Fahrenheit. It is also flame resistant to a 2-second flameout. This material is 70% solid and 30% open, allowing wind to pass through it. When placed on a ground surface, it can withstand 20 knots of surface wind without becoming folded or displaced.

The marker is lightweight, weighing 75 pounds total, such that it can be readily moved and placed by a single individual, simply by rolling it up and carrying it. The material of the preferred embodiment is thin, or flat, particularly when the thickness dimension is compared to the width and length dimensions. As a result, it can also be rolled up for easy storage, taking up minimal storage space.

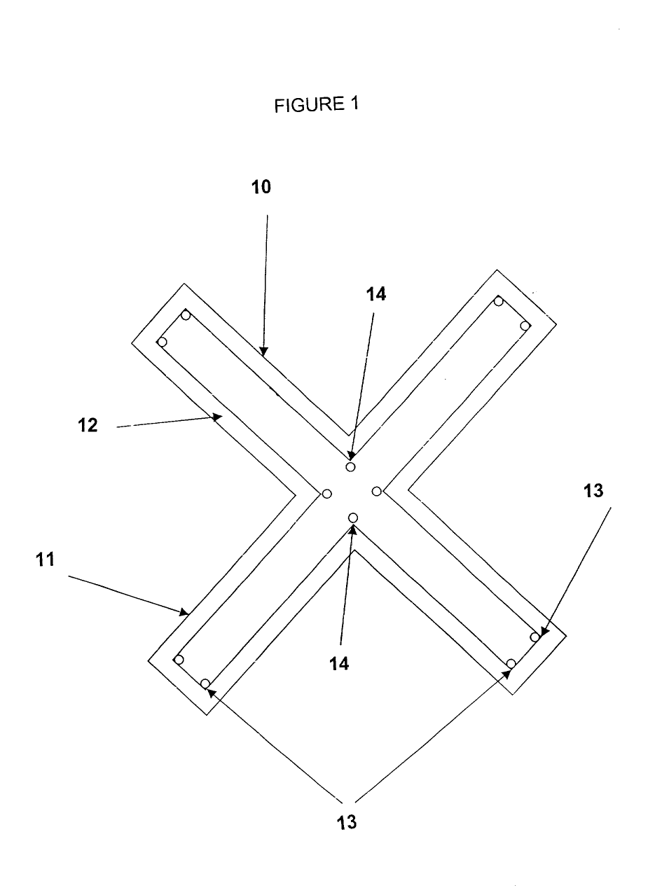

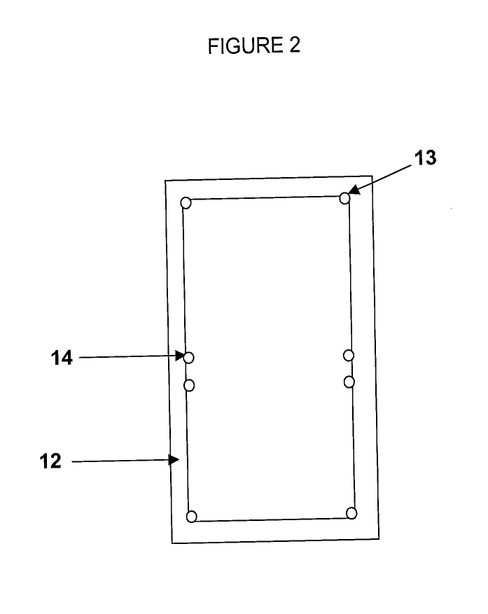

FIG. 1 depicts the preferred embodiment for a runway-sized marker as seen from above. It is comprised of two like rectangular sections or components, 10 and 11, that are placed across each other to form an “X” or cross-shape. A single preferred embodiment rectangular section is depicted in FIG. 2. In the preferred embodiment, each rectangular section is approximately sixty feet long and approximately eight feet wide. These rectangular components are yellow in color, with a six-inch black vinyl coated border 12 traversing the entire perimeter, such that the resulting “X” is a highly visible yellow with a black border. For ease of manufacture, the black border 12 is actually a twelve-inch wide strip of vinyl-coated material that is folded about the perimeter edge of each rectangular section and secured with stitching.

As depicted in FIG. 2, an element for receiving a fastener, such as a donut-shaped steel grommet 13, is placed in each of the four corners of both rectangular components, approximately six inches in from each side. These elements allow the marker to be fastened to the ground or other horizontal surface, whether that surface be pavement, soil or metal, using fasteners such as stakes, nails, screws, hooks, clips or other fasteners known to the art. Those skilled in the art will recognize that other means can be used to anchor this invention to the ground surface. For instance, sandbags can simply be placed at each corner of the marking, with ropes through each grommet.

In the preferred embodiment, as shown in FIG. 1 and 2, there are four additional grommets 14 located such that when the two sections are placed one on top of the other in a criss-cross fashion to form a symmetrical “X” marker, each of the four center grommets 14 on one component will be lined up with the corresponding grommets on the other component, one above the other. These center grommets 14 allow the two sections to be secured to each other in addition to the ground surface. In the preferred embodiment, these center grommets are located approximately twenty-six-and-one-half feet from the lengthwise end of each section and six inches from the widthwise end, as depicted in FIG. 2.

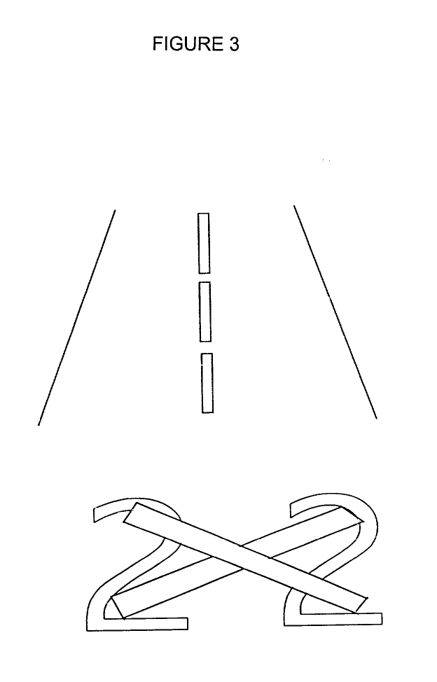

This marker can be placed at entrance ways to runways, as depicted in FIG. 3, or any other location as is desired. The preferred embodiment for a taxiway-sized marker is similar to the preferred embodiment for the runway-sized marker, with the exception of the dimensions. For the taxiway-sized marker, each rectangular section is thirty feet by four feet.

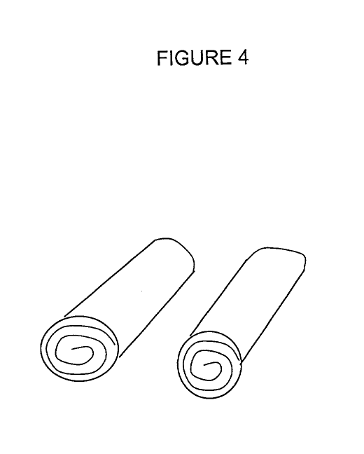

In use, the present invention may be removed from storage, unrolled, and temporarily affixed to the ground surface. In the preferred embodiment, the grommets may be hooked to the receptacles placed in the ground. In the preferred use of this present invention, the marker is affixed directly above the numerals which are typically printed on the ground surface to designate the runway member. If the nature of the construction prevents the marker from being placed directly above the runway number, then the marker of the present invention maybe placed off of the runway, along the extended runway centerline. When in this configuration, the airport traffic authority will be able to effectively communicate to air traffic—whether on the ground or in the air—that the marked runway is closed to traffic. When the airport traffic authority wishes to communicate that the marked runway or taxiway is re-opened, the present invention is removed from the ground surface, rolled up and placed back into storage. The two components of the preferred embodiment are shown in a rolled-up configuration in FIG. 4.

The foregoing is intended to fully teach and disclose the invention and to disclose preferred embodiments, but those skilled in the art will readily recognize that the present invention can be practiced with various modifications, such as but not limited to, various shapes, sizes, materials, including fabric, leather or metal, various colors, fasteners or elements for receiving fasteners, ground surface anchoring methods and components, etc. uses, including marker systems for air or ground traffic on ships, roadways, landing pads, and floating docks, which are all well-known in the art without departing from the spirit and scope of the present invention.

What is claimed is:

1. A marker system for directing air or ground traffic, comprising:
(a) a marker;
(b) said marker having a shape that conveys information to air or ground traffic;
(c) said marker being displayed on a generally horizontal surface in a generally horizontal fashion;
(d) said marker being at least large enough to be seen by air traffic and ground traffic when displayed in a generally horizontal fashion; and,
(e) said marker being capable of being moved.

2. The marker system of claim 1, wherein:
(a) said marker comprises multiple components; and,
(b) wherein said multiple components are arranged in relation to each other to form a shape that conveys information to air or ground traffic.

3. The marker system of claim 2, further comprising:
(a) one or more elements for receiving at least one fastener; and,
(b) wherein said marker is removably attachable to the horizontal surface by fasteners fastened in combination with said one or more elements for receiving at least one fastener.

4. The marker system of claim 3, wherein said one or more elements for receiving at least one fastener comprise grommets.

5. The marker system of claim 3, wherein said horizontal surface is selected from the group consisting essentially of a runway, a taxiway, a roadway, the ground, a ship, a floating dock, and a landing pad.

6. The marker system of claim 5, wherein said marker is made from a material that is selected from the group consisting essentially of fabric, plastic, leather, or metal, and a combination thereof.

7. The marker system of claim 6, wherein said material is sufficiently porous to allow air to pass through said marker.

8. The marker system of claim 6, wherein said material is more than approximately 70% open to air flow and less than approximately 30% closed to air flow.

9. The marker system of claim 6, wherein said material is less than approximately 70% closed to air flow and more than approximately 30% open to air flow.

10. The marker system of claim 6, wherein said material comprises vinyl coated nylon.

11. The marker system of claim 6, wherein said material is a highly visible color.

12. The marker system of claim 11, wherein said marker is yellow.

13. The marker system of claim 11, further comprising:
(a) a border;
(b) said border being located about the perimeter of said marker; and,
(c) said border color being different from said marker color.

14. The marker system of claim 13, wherein:
(a) said marker is yellow; and,
(b) said border is black.

15. A marker system for directing air or ground traffic, comprising:
(a) a first component;
(b) a second component;
(c) said first component and said second component being generally rectangular;
(d) said first component and said second component being displayed on a generally horizontal surface in a generally horizontal fashion;
(e) said first component being positioned in relation to said second component so as to form the shape of an “X” when viewed from above the horizontal surface; and,
(f) said first component and said second component being removably attachable to the horizontal surface.

16. The marker system of claim 15, further comprising:
(a) one or more elements for receiving at least one fastener;
(b) wherein at least one of said one or more elements for receiving at least one fastener is located at a corner of said first component;
(c) wherein at least one of said one or more elements for receiving at least one fastener is located at a corner of said second component; and,
(d) said first component and said second component being removably attachable to the horizontal surface by fasteners fastened in combination with said one or more elements for receiving at least one fastener.

17. The marker system of claim 16, wherein said one or more elements for receiving at least one fastener comprise a grommet.

18. The marker system of claim 16, wherein said horizontal surface is selected from the group consisting essentially of a runway, a taxiway, a roadway, the ground, a ship, a floating dock, and a landing pad.

19. The marker system of claim 18, wherein the marker is made from a material that is selected from the group consisting essentially of fabric, plastic, leather, or metal, and a combination thereof.

20. The marker system of claim 19, wherein said material is sufficiently porous to allow air to pass through said marker.

21. The marker system of claim 20, wherein said material is more than approximately 70% open to air flow and less than approximately 30% closed to air flow.

22. The marker system of claim 20, wherein said material is less than approximately 70% closed to air flow and more than approximately 30% open to air flow.

23. The marker system of claim 20, wherein said material comprises vinyl coated nylon.

24. The marker system of claim 23, wherein said material is a highly visible color.

25. The marker system of claim 24, wherein said marker is yellow.

26. The marker system of claim 24, further comprising:
(a) a border;
(b) said border being located about the perimeter of said marker; and,
(c) said border color being different from said marker color.

27. The marker system of claim 26, wherein:
(a) said marker is yellow; and
(b) said border is black.

28. The marker system of claim 24, further comprising:
(a) at least one of said one or more elements for receiving at least one fastener being located at the junctions of said first component and said second component; and,
(b) said first component and said second component being removably attachable to the horizontal surface and to each other by fasteners fastened in combination with said one or more elements for receiving at least one fastener.

29. The marker system of claim 27, wherein:
(a) said first component and said second component are each approximately sixty feet long and eight feet wide; and,
(b) said borders are six inches wide.

30. The marker system of claim 27, wherein:
(a) said first component and second components are approximately thirty feet long and four feet wide; and,
(b) said borders are six inches wide.

31. A marker system for directing air or ground traffic, comprising:
(a) a first component;
(b) a second component;
(c) said first component and said second component being generally rectangular;
(d) said first component and said second component being displayed on a generally horizontal surface in a generally horizontal fashion;
(e) said first component being positioned in relation to said second component so as to form the shape of an “X” when viewed from above the horizontal surface:
(f) one or more grommets wherein at least one of said one or more grommets is located at each corner of said first component;
(g) wherein at least one of said one or more grommets is located at each corner of said second component;
(h) said first component and said second component being removably attachable to the horizontal surface by stakes through said one or more grommets located in each corner of said first component and said second component;
(i) wherein at least four of said one or more grommets are located in said first component at the junction where said first component and said second component overlap;
(j) wherein at least four of said one or more grommets are located in said second component at the junction where said first component and said second component overlap;
(k) said first component and said second component being removably attachable to the horizontal surface and to each other by stakes placed through said one or more grommets located at the junction where said first component and said second component overlap;
(l) said first component and said second component being made of vinyl coated nylon; a border;
(m) said border being located about the perimeter of said first component and said second component;
(n) said first component and said second component being high visibility yellow;
(o) said border being black;
(p) said first component and said second component each being sixty feet long;
(q) said first component and said second component each being eight feet wide; and,
(r) said border being six inches wide.

32. The marker system of claim 31, wherein:
(a) said first component and said second component are thirty feet long; and,
(b) said first component and said second component are four feet wide.
